(19) United States
(12) Patent Application Publication
(10) Pub. No.: US 2025/0039679 A1
(43) Pub. Date: Jan. 30, 2025

(54) Selection of Cooperating Access Points in a Communication Network

(71) Applicant: Telefonaktiebolaget LM Ericsson (publ), Stockholm (SE)

(72) Inventors: Peiliang Chang, Åkersberga (SE); Mats Zachrison, Örebro (SE); Lars Peter Pehrson, Sollentuna (SE); Henrik Nyberg, SOLNA (SE)

(73) Assignee: Telefonaktiebolaget LM Ericsson (publ), Stockholm (SE)

(21) Appl. No.: 18/716,159

(22) PCT Filed: Dec. 17, 2021
(86) PCT No.: PCT/SE2021/051279

§ 371 Date: Jun. 4, 2024

(51) Int. Cl. H04W 16/14

(52) U.S. Cl. CPC H04W 16/14

(57) ABSTRACT

There is provided mechanisms for selecting links for running cooperative communication between access points in a communication network. A method is performed by a controller. The method comprises estimating, as a function of live network data obtained from the access points, a link utility for each link between each pair of access points as achieved if running the cooperative communication on said link. The method comprises selecting, as a function of the respective estimated link utility for each pair of access points, a subset of all links between the access points yielding optimal total aggregated link utility for a condition on a maximum number of links per access points for running the cooperative communication.

### TECHNICAL FIELD

Embodiments presented herein relate to a method, a controller, a computer program, and a computer program product for selecting links for running cooperative communication between access points in a communication network.

### BACKGROUND

In communication networks, there may be a challenge to obtain good performance and capacity for a given communication protocol, its parameters and the physical environment in which the communication network is deployed.

For example, one parameter in providing good performance and capacity for a given communication network is cooperation between access points deployed in the communication network. In further detail, in access networks, multiple access points might be configured to cooperate and jointly serve users, such as user equipment. Such cooperative communication can significantly improve the service quality of the served users. For example, the quality of received signals for users at the cell edge can be enhanced by coherent transmission of signals from multiple access points; the downlink transmission data rate for a user can be boosted by applying carrier aggregation and by serving the users with several carrier components from multiple access points.

In order to achieve good performance of cooperative communication, data (both control data and user data) should be exchanged between the cooperating access points with large bandwidth and low latency. Once pairs of access points that should cooperate with each other have been selected, transport links between the thus cooperating access points of each pair can be set up to enable such fast and large-bandwidth data exchange. However, due to hardware and software limitations, any given access point might only be capable of having a fast data exchange with a limited number of other access points. The number of different ways in which the selection of which of the access points that should cooperate with each other grows as the number of access points in the communication network grows. Hence, the problem of selecting pairs of access points that should cooperate with each other becomes more difficult to solve as the number of access points in the communication network grows. Some alternatives to address these issues will be disclosed next.

A first alternative involves arbitrary selecting the pairs of access points that should cooperate with each other. One potential issue with the first alternative is that the arbitrary selection does not take any consideration of the potential gain of cooperation between the cooperating access points. Therefore, no performance improvement can be guaranteed.

A second alternative is to perform a node-per-node selection where each access point selects its cooperating access point, or access points, based on its own observations. One potential issue with the second alternative is that there might be conflicts between the selection of cooperating access points made by the different access points. Agreements between access points need be reached to resolve potential conflicts. This may take unnecessarily long time. A high amount of data might be required to be communicated between the access points for reaching such agreements. Further, since each individual access point selects its cooperating access points solely based on its own observation, this alternative may not achieve optimal performance from a network perspective.

A third alternative is to detect communities among the access points in the communication network. Access points in the communication network can thereby be clustered into disjoint groups where each group contains up to (1+N) access points, where N is the maximum number of partners (i.e., cooperating access points) that each access point can have. Transport links can then be set up between all access points within the same group, or community, that has been identified. One potential issue with the third alternative is that each access point is limited to form partnership with the access points in the same cluster and there is no cooperation between access points of different clusters. A consequence of this is that users at the cell edges may not benefit from the cooperative communication. This alternative may therefore not achieve optimal performance from a network perspective.

Hence, there is still a need for improved techniques for selecting cooperating access points in a communication network.

### SUMMARY

An object of embodiments herein is to provide efficient selection of cooperating access points in a communication network where the above identified issues are overcome, or at least mitigated or reduced.

According to a first aspect there is presented a method for selecting links for running cooperative communication between access points in a communication network. The method is performed by a controller. The method comprises estimating, as a function of live network data obtained from the access points, a link utility for each link between each pair of access points as achieved if running the cooperative communication on said link. The method comprises selecting, as a function of the respective estimated link utility for each pair of access points, a subset of all links between the access points yielding optimal total aggregated link utility for a condition on a maximum number of links per access points for running the cooperative communication.

According to a second aspect there is presented a controller for selecting links for running cooperative communication between access points in a communication network. The controller comprises processing circuitry. The processing circuitry is configured to cause the controller to estimate, as a function of live network data obtained from the access points, a link utility for each link between each pair of access points as achieved if running the cooperative communication on said link. The processing circuitry is configured to cause the controller to select, as a function of the respective estimated link utility for each pair of access points, a subset of all links between the access points yielding optimal total aggregated link utility for a condition on a maximum number of links per access points for running the cooperative communication.

According to a third aspect there is presented a controller for selecting links for running cooperative communication between access points in a communication network. The controller comprises an estimate module configured to estimate, as a function of live network data obtained from the access points, a link utility for each link between each pair of access points as achieved if running the cooperative communication on said link. The controller comprises a select module configured to select, as a function of the respective estimated link utility for each pair of access points, a subset of all links between the access points yielding optimal total aggregated link utility for a condition on a maximum number of links per access points for running the cooperative communication.

According to a fourth aspect there is presented a computer program for selecting links for running cooperative communication between access points in a communication network, the computer program comprising computer program code which, when run on a controller, causes the controller to perform a method according to the first aspect.

According to a fifth aspect there is presented a computer program product comprising a computer program according to the fourth aspect and a computer readable storage medium on which the computer program is stored. The computer readable storage medium could be a non-transitory computer readable storage medium.

According to a sixth aspect there is presented a system. The system comprises a controller according to the second or third aspect and the access points.

Advantageously, these aspects provide efficient selection of cooperating access points in a communication network.

Advantageously, the proposed aspects for selecting cooperating access points in a communication network overcome the above noted issues.

Advantageously, these aspects aim to optimize the selection of cooperating access point on network level. The potential cooperating access points of an access point are not confined to be selected from a closed group and there are no disjoint clusters of access points. The end result might yield lower local performance improvement (such as per a given access point) compared to a per node or per community selection, but yields better network level performance.

Advantageously, since the proposed aspects for selecting cooperating access points are driven by data collected from live networks, the selection of cooperating access points can be adapted to specific network conditions, such as coverage and traffic conditions. When there is any change in cell coverage, traffic load or transport connectivity between access points, the selection of cooperating access points can be updated accordingly.

Advantageously, these aspects can be used to achieve automatic network configuration, without any human intervention.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIG. 2 schematically illustrates an example of inter-node carrier aggregation according to an embodiment;

FIGS. 3 and 6 are flowcharts of methods according to embodiments;

FIGS. 4 and 5 schematically illustrate access points and links between the access points according to embodiments;

FIG. 7 is a schematic diagram showing functional units of a controller according to an embodiment;

FIG. 8 is a schematic diagram showing functional modules of a controller according to an embodiment; and

FIG. 9 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

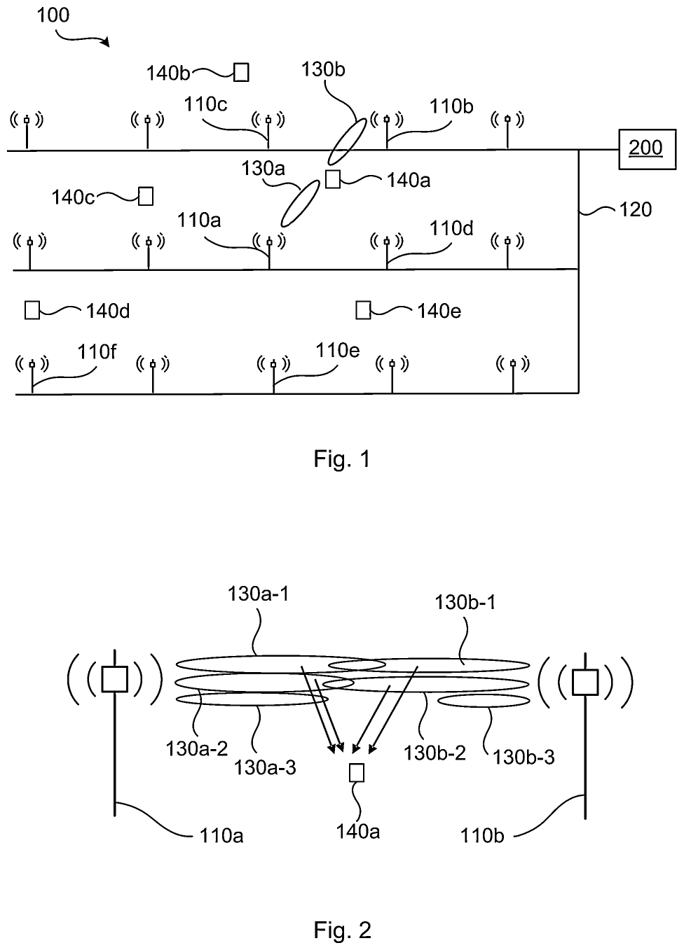

FIG. 1 is a schematic diagram illustrating a communication network 100 where embodiments presented herein can be applied. The communication network 100 comprises access points 110a:110f. The access points 110a:110f are operatively connected over a link 120 to a controller 200. The access points 110a:110f are configured to provide network access to users 140a:140e in cells, where two such cells are schematically illustrated at 130a, 130b. A system might comprise the controller 200 and the access points 110a:110f. Examples of access points 110a:110f are radio access network nodes, radio base stations, base transceiver stations, Node Bs, evolved Node Bs, gNBs, and integrated access and backhaul nodes. Examples of users 140a:140e are user equipment (UE), wireless devices, mobile stations, mobile phones, handsets, wireless local loop phones, smartphones, laptop computers, tablet computers, network equipped sensors, network equipped vehicles, and so-called Internet of Things devices.

As noted above there is still a need for improved techniques for selecting cooperating access points in a communication network. The embodiments disclosed herein in therefore relate to mechanisms for selecting links for running cooperative communication between access points 110a:110f in a communication network 100. In order to obtain such mechanisms, there is provided a controller 200, a method performed by the controller 200, a computer program product comprising code, for example in the form of a computer program, that when run on a controller 200, causes the controller 200 to perform the method.

According to at least some of the herein disclosed embodiments there are therefore provided techniques for data-driven partner selection for cooperative communications between the access points 110a:110f. A model might firstly be developed to estimate the potential performance gain, in terms of link utility, that can be achieved by the considered cooperative communication technique for each pair of access points. The model can be developed either with machine learning methods or based on domain knowledge. The selection of cooperating access points is based on live network data that can be measured or collected from the access points 110a:110f without any the considered cooperative communication being running between the access points 110a:110f. During runtime, the live network data is firstly collected by the controller 200 and the potential benefit of each candidate pair of cooperating access points is estimated using the model. Based on the estimated benefit, each candidate pair of access points is either selected or not selected by the controller 200. A greedy search algorithm might be used to select out the top-ranked candidate pairs of access points. Those selected pairs would be configured as the cooperating access points and fast links would be set up between the access points of the selected pairs.

An introductory illustrative example where the link utility pertains to inter-node carrier aggregation (CA) for each pair of access points 110a:110f will now be disclosed. The inter-node CA as used in communication networks 100 based on Long Term Evolution (LTE) and New Radio (NR) techniques is a typical example of cooperative communications in a radio access network. The partner selection problem in inter-node carrier aggregation is firstly introduced.

Consider a communication network 100 comprising N access points and one controller 200, as in FIG. 1. A number of frequency carriers, or just carriers for short, is assumed to be deployed on each access point 110a:110f for serving the users 140a:140e over a radio interface. Inter-node CA can be applied to boost the downlink data rate of users in the network. One example of inter-node CA is illustrated in FIG.

2. In this example, there are two access points 110a, 110b and each access point 110a, 110b deploys three carriers, as represented by cells 130a-1, 130a-2, 130a-3, 130b-1, 130b-2, and 130b-3. A user 140a in the communication network 100 is covered by both cells of both access points 110a, 110b. By applying inter-node CA between access point 110a and access point 110b, the user can be served by up to four carriers (i.e., cells 130a-1 and 130a-2 of access point 110a, and cells 130b-1 and 130b-2 of access point 110b) and achieve higher data rate, due to the access to larger bandwidth.

The performance of inter-node carrier aggregation depends on the data exchange on the link between the access points 110a, 110b. Data exchange with low latency and large bandwidth can improve the performance of inter-node CA. Fast data exchange between the access points 110a, 110b commonly consumes significant resources, such as bandwidth and processing usage. Due to resource constraints, a given access point 110a:110f can only cooperate with a limited number of other access points 110a:110f with low latency and large bandwidth, rather than all the access points 110a:110f. Issues with existing techniques for selecting cooperating access points in a communication network have been mentioned above.

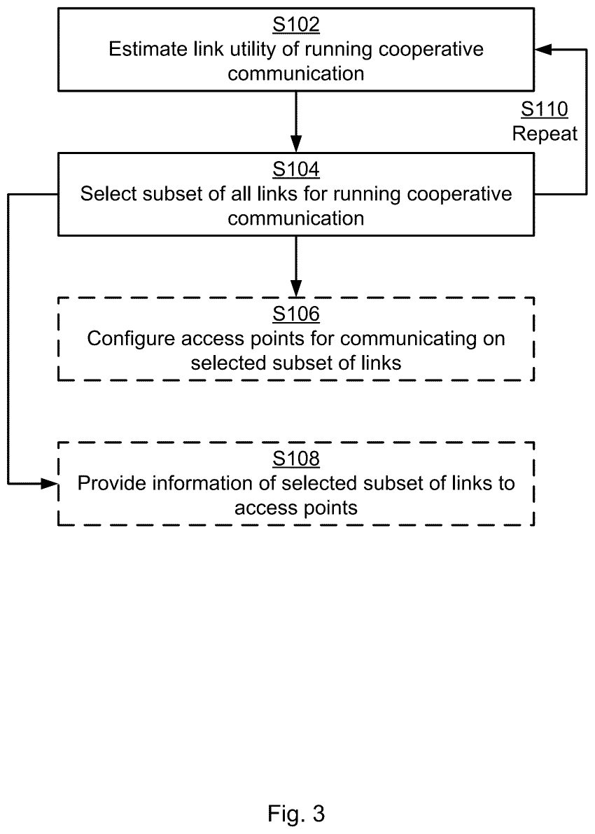

FIG. 3 is a flowchart illustrating embodiments of methods for selecting links for running cooperative communication between access points 110a:110f in a communication network 100. The methods are performed by the controller 200. The methods are advantageously provided as computer programs 920.

The links for running cooperative communication between the access points 110a:110f are selected based on live network data. Based on the live network data, the controller estimates a link utility for each link between each pair of access points 110a:110f. In particular, the controller 200 is configured to perform step S102 and step S104:

S102: The controller 200 estimates, as a function of live network data obtained from the access points 110a:110f, a link utility for each link between each pair of access points 110a:110f as achieved if running the cooperative communication on the link.

S104: The controller 200 selects, as a function of the respective estimated link utility for each pair of access points 110a:110f, a subset of all links between the access points 110a:110f yielding optimal total aggregated link utility for a condition on a maximum number of links per access points 110a:110f for running the cooperative communication.

Since there is a pair of access points 110a:110f for each of the links, the selected subset of links defines cooperating access points 110a:110f in the communication network 100. With live network data is meant that the selection is based on network data that can be measured or collected from the access points 110a:110f whilst these are operating and thus serving traffic to and from the users 140a:140e. Network data measured or collected whilst the communication network 100 thus is running is referred to as live network data. Some of the live network data may replace previously collected or measured network data, such as when access points 110a:110f are added or removed from the communication network 100 or when the coverage of a cell 130a, 130b is changed. Further, the live network data may build on previously collected or measured network data such as where traffic is generated, and the loads of traffic. When using live network data such as traffic information, preference may be given to the most currently received live network data when the cooperating access points 110a:110f.

That the subset of links that yields optimal total aggregated link utility is selected implies that the subset of links is selected according to a total aggregated link utility optimality criterion. The selection of the subset of links might target maximum total aggregated link utility. Thus, the subset of links is selected such that the total aggregated link utility is as good as possible (based on the obtained live network data and conditioned in the maximum number of links per access points 110a:110f for running the cooperative communication).

Embodiments relating to further details of selecting links 410, 420, 510, 520 for running cooperative communication between access points 110a:110f in a communication network 100 as performed by the controller 200 will now be disclosed.

There could be different examples of live network data. In some embodiments, the live network data is obtained from the access points 110a:110f in terms of cell coverage data and cell load data for all cells deployed by the access points 110a:110f, without any cooperative communication running between the access points 110a:110f.

There could be different ways to represent the link utility. In some embodiments, the link utility is represented by a set of entries, with one entry per each link between two of the access points 110a:110f. The entry for a given link represents the estimated link utility achieved if running the cooperative communication between the access points 110a:110f of this given link. In this respect, each link might be either bidirectional or unidirectional. If the links are bidirectional, there is one entry per each pair of access points 110a:110f. If the links are unidirectional, they are two entries per each pair of access points 110:110f. In the latter case, the two entries of one pair of access points 110a:110f can have different values. Further, in the latter case there could be situations where, for a given pair of access points 110a:110f, only one out of the two unidirectional links is selected.

With respect to S104, the subset of all links might be selected by selecting a subset of the entries yielding optimal total aggregated link utility. Since there is a pair of access points 110a:110f for each of the links, the selected subset of entries might then define the cooperating access points 110a:110f in the communication network 100.

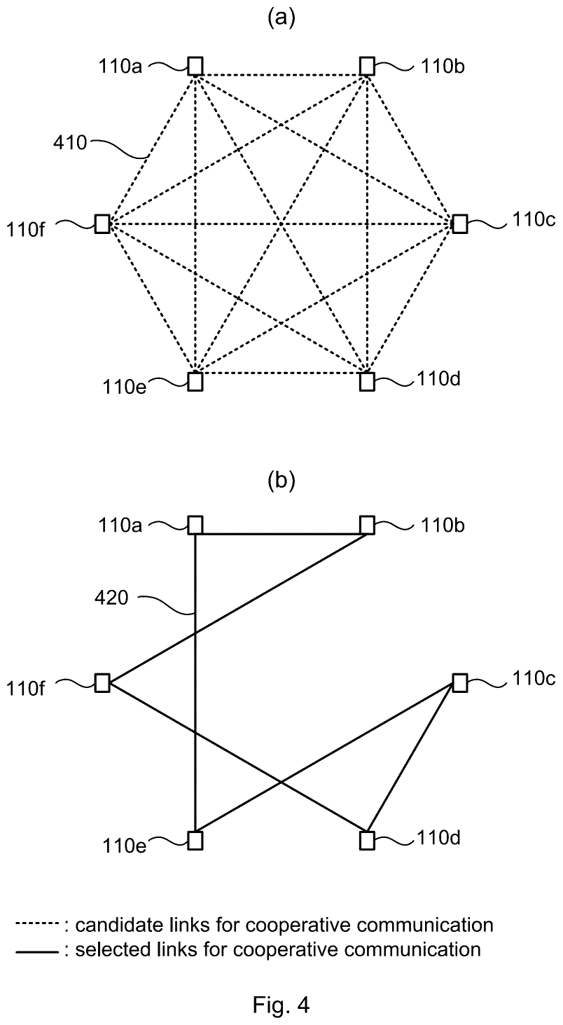

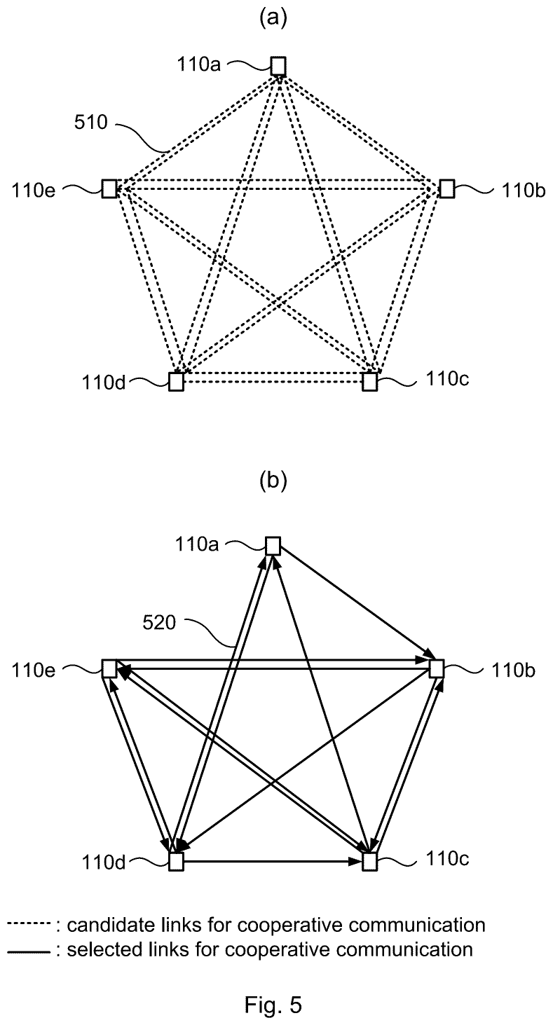

Intermediate reference is here made to FIG. 4 and FIG. 5. FIG. 4 shows six access points 110a:110f and links 410, 420 between the access points 110a:110f. FIG. 5 shows five access points 110a:110e and links 510, 520 between the access points 110a:110e. FIG. 4 represents a case with bidirectional links 410, 420. FIG. 5 represents a case with unidirectional links 510, 520, where the direction of each link 510, 520 is illustrated by an arrow. Links 410, 510 illustrated with dashed lines represent possible candidate links that are selectable for cooperative communication between the access points. Links 420, 520 illustrated with solid lines represent the selected links for cooperative communication between the access points.

As disclosed above, the links 420, 520 are selected based on a condition on a maximum number of links per access points for running the cooperative communication. In the illustrative example of FIG. 4, each access point 110a:110f is assumed to have a maximum of 2 links.

In yet further aspects, there is a condition also on the directivity of the links, as applicable in the unidirectional case. For example, each access point 110a:110f might only be configured with interfaces for some limited number of links in each direction. For example, a given access point 110a:110f might comprise equally or unequally many interfaces for reception of signals from another access point as there are for transmission of signals towards another access point. Therefore, in some embodiments, the subset of links 510, 520 is selected for a condition on a total maximum number of links 510, 520 in each direction (i.e., transmission and reception) per each of the access points 110a:110e for running the cooperative communication. In the illustrative example of FIG. 5, each access point 110a:110e is assumed to have a maximum of 3 links each for transmission and reception of signals.

There could be different ways to select the subset of links 420, 520 from all available links 410, 510. In some embodiments, the subset of links 420, 520 is selected using a greedy search algorithm.

Once the subset of links 420, 520 has been selected, the controller 200 might configure the access points 110a:110f for cooperative communication in accordance with the selected subset of links 420, 520. In particular, the controller 200 is configured to perform (optional) step S106:

S106: The controller 200 configures the access points 110a:110f for communicating on the selected subset of links 410, 420, 510, 520.

Additionally or alternatively, the access points 110a:110f might be provided with information of which links 420, 520 that have been selected for cooperative communication. In particular, the controller 200 is configured to perform (optional) step S108:

S108: The controller 200 provides information indicating the selected subset of links 410, 420, 510, 520 to the access points 110a:110f.

The access points 110a:110f might, upon step S106 and/or step S108 having been performed, initiate cooperative communication over the selected subset of links 410, 420, 510, 520.

In some aspects, the selection of cooperating access points 110a:110f is updated. The update might be performed either on regular time intervals, as determined by network configuration, or upon new line network data being available. In particular, the controller 200 is configured to perform (optional) step S110:

S110: The controller 200 repeatedly performs at least the estimating in S102 and the selecting in S104 as new live network data is obtainable by the controller 200.

The selection of cooperating access points 110a:110f can thereby be updated upon a change in cell coverage, traffic load, transport connectivity between the access points 110a:110f, etc.

There could be different examples of the link utility. In some non-limiting and illustrative examples, the link utility pertains to cooperation between the access points 110a:110f in terms of any of: inter-node CA, radio cooperative communication including but not limited to dynamic spectrum sharing (DSS) and CA between and within physical access nodes (such as gNBs and eNBs) and virtualized radio access networks (RANs), uplink Coordinated Multi-Point (CoMP) transmission/reception joint processing, centralized scheduling with distributed layer L1 and layer L2 communication, coordination for advanced antenna systems (AASs) between sector carriers, transmission-and-reception points (TRPs), cells, multi-TRP across sites and/or access points, slow scheduling coordination with fast interfaces in Packet Data Convergence Protocol (PDCP) signalling for E-UTRAN New Radio Dual Connectivity (EN-DC; where E-UTRAN is short for Evolved Universal Mobile Telecommunications System (UMTS) Terrestrial Radio Access Network) and New Radio Dual Connectivity (NR-DC), access network coordination to avoid/mitigate Quality of Experience (QoE) or Quality of Service (QOS) drops for access network services, redundant transmission paths with fast interconnect for e.g., ultra-reliable low latency communications (URLLC), fast inter-cell interference coordination (ICIC) for e.g., Dynamic Spectrum Sharing (DSS) interference mitigation.

There could be different ways to estimate the link utility in S102. In some non-limiting and illustrative examples, the link utility is estimated in terms of any of: number of active users 140a:140e served in each cell of each access point 110a:110f, probability that users 140a:140e of one access point 110a:110f are covered by any cell of another access point 110a:110f, probability that users 140a:140e served by one access point 110a:110f are able to use carriers of another access point 110a:110f, amount of un-used radio resources at each access point 110a:110f, access link quality between users 140a:140e served by one access point 110a:110f and another access point 110a:110f, latency of the links 410, 420, 510, 520 between the access points 110a:110f, policies in the communication network 100, capabilities of the access points 110a:110f for cooperative communication. For example, due to network or access point capability limitation, it might not be possible to set up a fast link between a pair of access point. The link utility between these access points will then be set to zero.

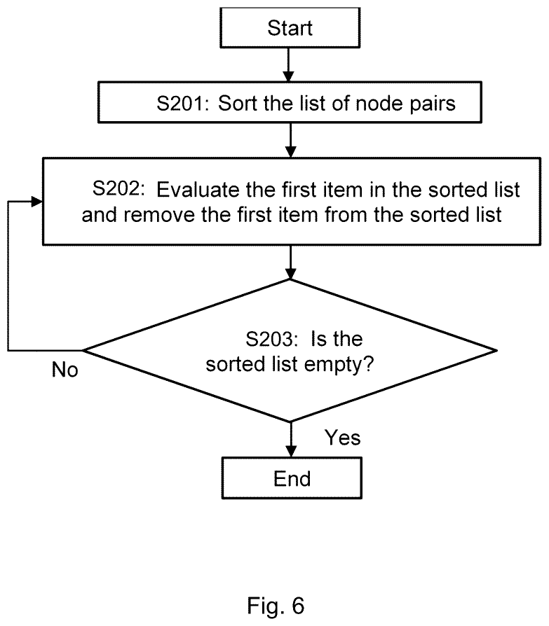

One particular embodiment for selecting links 410, 420, 510, 520 for running cooperative communication between access points 110a:110f in a communication network 100 as performed by the controller 200 will be disclosed next with reference to the flowchart of FIG. 6.

A list of entries with link utility values for links between pairs of access points 110a:110f is obtained. The controller 200 further keeps an empty list of pairs of cooperating access point.

S201: The list of entries is sorted according to the link utility values in descending order. The larger the link utility value of a given entry is, the higher the pair of access points corresponding to the given entry is ranked.

S202: The first entry in the thus sorted list is evaluated for the controller 200 to determine whether the corresponding pair of access points should be added to the list of cooperating access point pairs. This is done by the controller 200 checking whether the number of configured cooperating access points has reached a maximum limit for each of the access points in the pair given by this entry. If the number of configured cooperating access points of both access points in of the pair given by the entry is smaller than their maximum number of cooperating access points, the pair of access points given by this entry is added to the list of cooperating access point pairs. The number of configured cooperating access points is incremented by one for both access points in the pair. Otherwise (i.e., if the number of configured cooperating access points of both access points in of the pair given by the entry is not smaller than their maximum number of cooperating access points) this pair of access points is not added to the list of cooperating access point pairs. The first item in the sorted list is then removed from the sorted list.

S203: A check is made whether the sorted list is empty or not. If the sorted list is not empty, step S202 is entered again. Otherwise, the procedure is ended and the list of cooperating access point pairs is provided as output.

Illustrative examples where the link utility pertains to inter-node carrier aggregation (CA) for each pair of access points 110a:110f will now be disclosed.

In some examples, the link utility is the number of users that can be covered by cells of both access points of each pair of access points. For a pair of access points i and j, their link utility, hereinafter denoted U_{i,j}, can be estimated as:

$${U}_{i , j} = {K}_{i}^{j} + {K}_{j}^{i} , \qquad ( 1 )$$

$$with$$

$${K}_{i}^{j} = {\sum }_{m , n} {k}_{i , m}^{j , n} = {\sum }_{m , n} {N}_{i , m} {P}_{i , m}^{j , n} \qquad ( 1 - 1 )$$

Kᵢ^{j} represents the overall number of users that get connected over radio resource control (RRC) signalling with cells of access point i and use cells of access point j as secondary carrier components; k_{i,m}^{j,n} is the overall number of users that get connected over RRC signalling with access point m of access point i and use cell n of access point j; where k_{i,m}^{j,n} can be estimated as k_{i,m}^{j,n}=N_{i,m}P_{i,m}^{j,n}, where N_{i,m} is the number of users that get connected over RRC signalling with cell m of access point i; and P_{i,m}^{j,n} is the probability that users which get connected over RRC signalling with cell m of access point i are covered by cell m of access point j.

In some examples, the link utility is the amount of radio resources (e.g. the number of physical resource blocks; PRBs) that can be used for inter-node CA. For a pair of access points i and j, their link utility can be estimated as:

$${U}_{i , j} = {R}_{i}^{j} + {R}_{j}^{i} , \qquad ( 2 )$$

$$with$$

$${R}_{i}^{j} = {\sum }_{m , n} {r}_{i , m}^{j , n} = {\sum }_{m , n} {N}_{i , m} {W}_{j , n} {P}_{i , m}^{j , n} \qquad ( 2 - 1 )$$

Rᵢ^{j} represents the overall amount of radio resources that can be accessed by the users that get connected over RRC signalling with cells of access point i and use cells of access point j as secondary carrier components; r_{i,m}^{j,n} is the overall amount of radio resources that can be accessed by the users that get connected over RRC signalling with cell m of access point i and use cell n of access point j; r_{i,m}^{j,n} can be estimated as r_{i,m}^{j,n}=N_{i,m}W_{j,n}P_{i,m}^{j,n}, where N_{i,m} is the number of users that get connected over RRC signalling with cell m of access point i; W_{j,n} is the available radio bandwidth at cell n of access point j; P_{i,m}^{j,n} is the probability that users, which get connected over RRC signalling with cell m of access point i, are covered by cell m of access point j.

In some examples, the link utility is estimated as the potential inter-node CA throughput. For a pair of access points i and j, their link utility can be estimated as:

$${U}_{i , j} = {T}_{i}^{j} + {T}_{j}^{i} , \qquad ( 3 )$$

$$with$$

$${T}_{i}^{j} = {\sum }_{m , n} {t}_{i , m}^{j , n} = {\sum }_{m , n} {N}_{i , m} {W}_{j , n} {P}_{i , m}^{j , n} {S}_{i , m}^{j , n} \qquad ( 3 - 1 )$$

Tᵢ^{j} represents the sum of the CA throughputs that can be achieved by the users that get connected over RRC signalling with cells of access point i and use cells of access point j as secondary carrier components; t_{i,m}^{j,n} is the sum of the CA throughputs that can be achieved by the users that get connected over RRC signalling with cell m of access point i and use cell n of access point j; t_{i,m}^{j,n} can be estimated as t_{i,m}^{j,n}=N_{i,m}W_{j,n}P_{i,m}^{j,n}S_{i,m}^{j,n}, where N_{i,m} is the number of users that get connected over RRC signalling with cell m of access point i; W_{j,n} is the available radio bandwidth at cell n of access point j; P_{i,m}^{j,n} is the probability that users, which get connected over RRC signalling with cell m of access point i, are covered by cell m of access point j; S_{i,m}^{j,n} is the average spectral efficiency of the access links of user connected over RRC signalling with cell m of access point i, and cell m of access point j.

In some examples, the transport connectivity between the access points can be considered to estimate the link utility as the inter-node CA throughput depends on the latency and bandwidth of the transport link between the access points. With consideration of transport connectivity, for a pair of access points i and j, their link utility can be estimated as:

$${U}_{i , j} = {T}_{i}^{j} + {T}_{j}^{i} , \qquad ( 4 )$$

$$with$$

$${T}_{i}^{j} = {\sum }_{m , n} {t}_{i , m}^{j , n} = {\sum }_{m , n} {N}_{i , m} {W}_{j , n} {P}_{i , m}^{j , n} {S}_{i , m}^{j , n} {β}_{i , j} \qquad ( 4 - 1 )$$

Tᵢ^{j} represents the sum of the CA throughputs that can be achieved by the users that get connected over RRC signalling with cells of access point i and use cells of access point j as secondary carrier components; t_{i,m}^{j,n} is the sum of the CA throughputs that can be achieved by the users that get connected over RRC signalling with cell m of access point i and use cell n of access point j; t_{i,m}^{j,n} can be estimated as t_{i,m}^{j,n}=N_{i,m}W_{j,n}P_{i,m}^{j,n}S_{i,m}^{j,n}β_{i,j}, where N_{i,m} is the number of users that get connected over RRC signalling with cell m of access point i; W_{j,n} is the available radio bandwidth at cell n of access point j; P_{i,m}^{j,n} is the probability that users, which get connected over RRC signalling with cell m of access point i, are covered by cell m of access point j; S_{i,m}^{j,n} is the average spectral efficiency of the access links of the user connected over RRC signalling with cell m of access point i, and cell m of access point j; β_{i,j} is a factor that could range from a minimum value (such as 0) to a maximum value (such as 1) to captures the impact of transport connectivity between access point i and access point j on achievable throughput of inter-node CA. If the latency of the transport link between two access points is below a threshold γ₁, then β_{i,j} is equal to the maximum value, and if the latency of the transport link between two access points is above another threshold γ₂ with γ₂ larger than γ₁, then β_{i,j} is equal to the minimum value. If the latency of a transport link between two access points is in between γ₁ and γ₂, where β_{i,j} is between the minimum value and the maximum value, and the larger the latency is, the smaller β_{i,j} is.

The link utility might also depend on how many of the users covered by carriers on the two access points that are able to use covering carriers. Therefore, the distribution of supported bands by the users can be used to estimate the link utility and to enhance the above examples. For example, in Equations (1-1), (2-1), (3-1), and (4-1), a further factor ζ_{i,m}^{j,n} can be added as a multiplication factor, where ζ_{i,m}^{j,n} is the probability that users, which get connected over RRC signalling with cell m of access point i and are covered by cell n of access point j, can use these two carriers for CA.

The link utility might be represented by a set of entries, with one entry per link, that is used by the controller 200 to select a subset of all links between the access points 110a:110f, as in S104. Each item for the pair defined by access point i and access point j represents the estimated CA usage, as given by U_{i,j}, between these two access points.

In the foregoing, the embodiments, aspects, and examples, have mainly related to selecting pairs of access points with symmetric partner relationships, such as with bidirectional links between the access points 110a:110f. However, the herein disclosed embodiments, aspects, and examples can also be applied selecting pairs of access points with asymmetric partner relationships, such as with unidirectional links between the access points 110a:110f. This implies that, as disclosed above with reference to FIG. 5, there are two entries for each a pair of access points 110a:110e, where each of the entries for a given pair of access points 110a:110f is evaluated independently of the other entry for the same given pair of access points 110a:110f, instead of summing these two entries as is done in Equations (1), (2), (3), and (4). This also implies that each access point 110a:110e would have two constraints in step S202.

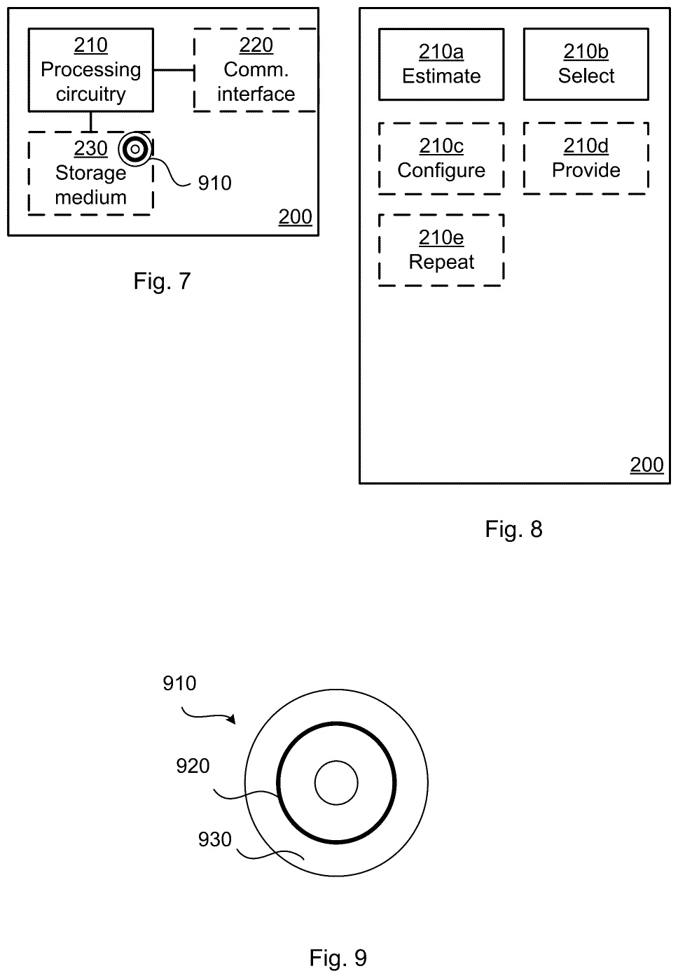

FIG. 7 schematically illustrates, in terms of a number of functional units, the components of a controller 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 910 (as in FIG. 9), e.g. in the form of a storage medium 230. The processing circuitry 210 may further be provided as at least one application specific integrated circuit (ASIC), or field programmable gate array (FPGA).

Particularly, the processing circuitry 210 is configured to cause the controller 200 to perform a set of operations, or steps, as disclosed above. For example, the storage medium 230 may store the set of operations, and the processing circuitry 210 may be configured to retrieve the set of operations from the storage medium 230 to cause the controller 200 to perform the set of operations. The set of operations may be provided as a set of executable instructions.

Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The controller 200 may further comprise a communications interface 220 at least configured for communications with other entities, functions, nodes, and devices of the communication network 100, such as the access points 110a:110f. As such the communications interface 220 may comprise one or more transmitters and receivers, comprising analogue and digital components. The processing circuitry 210 controls the general operation of the controller 200 e.g. by sending data and control signals to the communications interface 220 and the storage medium 230, by receiving data and reports from the communications interface 220, and by retrieving data and instructions from the storage medium 230. Other components, as well as the related functionality, of the controller 200 are omitted in order not to obscure the concepts presented herein.

FIG. 8 schematically illustrates, in terms of a number of functional modules, the components of a controller 200 according to an embodiment. The controller 200 of FIG. 8 comprises a number of functional modules; an estimate module 210a configured to perform step S102 and a select module 210b configured to perform step S104. The controller 200 of FIG. 8 may further comprise a number of optional functional modules, such as any of a configure module 210c configured to perform step S106, a provide module 210d configured to perform step S108, and a repeat module 210e configured to perform step S110. In general terms, each functional module 210a:210e may in one embodiment be implemented only in hardware and in another embodiment with the help of software, i.e., the latter embodiment having computer program instructions stored on the storage medium 230 which when run on the processing circuitry makes the controller 200 perform the corresponding steps mentioned above in conjunction with FIG. 8. It should also be mentioned that even though the modules correspond to parts of a computer program, they do not need to be separate modules therein, but the way in which they are implemented in software is dependent on the programming language used. Preferably, one or more or all functional modules 210a:210e may be implemented by the processing circuitry 210, possibly in cooperation with the communications interface 220 and/or the storage medium 230. The processing circuitry 210 may thus be configured to from the storage medium 230 fetch instructions as provided by a functional module 210a:210e and to execute these instructions, thereby performing any steps as disclosed herein.

The controller 200 may be provided as a standalone device or as a part of at least one further device. For example, the controller 200 may be provided in a node of the access network or in a node of the core network. Alternatively, functionality of the controller 200 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the controller 200 may be executed in a first device, and a second portion of the of the instructions performed by the controller 200 may be executed in a second device; the herein disclosed embodiments are not limited to any particular number of devices on which the instructions performed by the controller 200 may be executed. Hence, the methods according to the herein disclosed embodiments are suitable to be performed by a controller 200 residing in a cloud computational environment. Therefore, although a single processing circuitry 210 is illustrated in FIG. 7 the processing circuitry 210 may be distributed among a plurality of devices, or nodes. The same applies to the functional modules 210a:210e of FIG. 8 and the computer program 920 of FIG. 9.

FIG. 9 shows one example of a computer program product 910 comprising computer readable storage medium 930. On this computer readable storage medium 930, a computer program 920 can be stored, which computer program 920 can cause the processing circuitry 210 and thereto operatively coupled entities and devices, such as the communications interface 220 and the storage medium 230, to execute methods according to embodiments described herein. The computer program 920 and/or computer program product 910 may thus provide means for performing any steps as herein disclosed.

In the example of FIG. 9, the computer program product 910 is illustrated as an optical disc, such as a CD (compact disc) or a DVD (digital versatile disc) or a Blu-Ray disc. The computer program product 910 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 920 is here schematically shown as a track on the depicted optical disk, the computer program 920 can be stored in any way which is suitable for the computer program product 910.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for selecting links for running cooperative communication between access points in a communication network, the method being performed by a controller, the method comprising:
estimating, as a function of live network data obtained from the access points, a link utility for each link between each pair of access points as achieved if running the cooperative communication on said link; and
selecting, as a function of the respective estimated link utility for each pair of access points, a subset of all links between the access points yielding optimal total aggregated link utility for a condition on a maximum number of links per access points for running the cooperative communication.

2. The method according to claim 1, wherein the live network data is obtained from the access points in terms of cell coverage data and cell load data for all cells deployed by the access points, without any cooperative communication running between the access points.

3. The method according to claim 1, wherein the link utility is represented by a set of entries, with one entry per each link between two of the access points, and wherein the entry for a given link represents the estimated link utility achieved if running the cooperative communication between the access points of said given link.

4. The method according to claim 3, wherein the subset of all links is selected by selecting a subset of the entries yielding optimal total aggregated link utility.

5. The method according to claim 4, wherein the selected subset of entries defines cooperating access points in the communication network.

6. The method according to claim 1, wherein the subset of links is selected using a greedy search algorithm.

7. The method according to claim 1, wherein the subset of links is selected for a condition on a total maximum number of links in each direction per each of the access points for running the cooperative communication.

8. The method according to claim 1, wherein the method further comprises:
configuring the access points for communicating on the selected subset of links.

9. The method according to claim 1, wherein the method further comprises:
providing information indicating the selected subset of links to the access points.

10. The method according to claim 1, wherein the method further comprises:
repeatedly performing said estimating and said selecting as new live network data is obtainable by the controller.

11. The method according to claim 1, wherein the link utility pertains to cooperation between the access points in terms of any of: inter-node carrier aggregation, radio cooperative, uplink Coordinated Multi-Point transmission/reception joint processing, centralized scheduling with distributed layer L1 and L2 communication, coordination for advanced antenna systems between sector carriers transmission-and-reception points, TRPs, or cells, multi-TRP across sites and/or access points, slow scheduling coordination with fast interfaces in Packet Data Convergence Protocol signalling for EN-DC and NR-DC, access network coordination to avoid/mitigate Quality of Experience and/or Quality of Service drops for access network services, redundant transmission paths with fast interconnect.

12. The method according to claim 1, wherein the link utility is estimated in terms of any of: number of active users served in each cell of each access point, probability that users of one access point are covered by any cell of another access point, probability that users served by one access point are able to use carriers of another access point, amount of un-used radio resources at each access point, access link quality between users served by one access point and another access point, latency of the links between the access points, policies in the communication network, capabilities of the access points for cooperative communication.

13. A controller for selecting links for running cooperative communication between access points in a communication network, the controller comprising processing circuitry, the processing circuitry being configured to cause the controller to:
estimate, as a function of live network data obtained from the access points, a link utility for each link between each pair of access points as achieved if running the cooperative communication on said link; and
select, as a function of the respective estimated link utility for each pair of access points, a subset of all links between the access points yielding optimal total aggregated link utility for a condition on a maximum number of links per access points for running the cooperative communication.

14-16. (canceled)

17. A computer program for selecting links for running cooperative communication between access points in a communication network, the computer program comprising computer code which, when run on processing circuitry of a controller, causes the controller to:
estimate, as a function of live network data obtained from the access points, a link utility for each link between each pair of access points as achieved if running the cooperative communication on said link; and
select, as a function of the respective estimated link utility for each pair of access points, a subset of all links between the access points yielding optimal total aggregated link utility for a condition on a maximum number of links per access points for running the cooperative communication.

18. (canceled)
